(19) United States
(12) Patent Application Publication
(10) Pub. No.: US 2021/0129434 A1
(43) Pub. Date: May 6, 2021

(54) Apparatus for Additively Manufacturing Three-Dimensional Objects

(71) Applicant: Concept Laser GmbH, Lichtenfels (DE)

(72) Inventors: Philipp Schumann, Lichtenfels (DE); Jack Robert Crawley, London (GB)

(21) Appl. No.: 16/670,373

(22) Filed: Oct. 31, 2019

(51) Int. Cl. B29C 64/236; B33Y 30/00; B33Y 40/20; B29C 64/379; B29C 64/386; B33Y 50/00

(52) U.S. Cl. CPC B29C 64/236; B33Y 30/00; B33Y 40/20; B33Y 10/00; B29C 64/386; B33Y 50/00; B29C 64/379

(57) ABSTRACT

Apparatuses for additively manufacturing three-dimensional objects may include at least one interacting device comprising at least one functional unit, in particular a drone unit, adapted to fly across and/or hover in a movement region. Plants for additively manufacturing three-dimensional objects may include at least two apparatuses for additively manufacturing of three-dimensional objects and at least one interacting device, in particular for each apparatus, which interacting device may include at least one functional unit adapted to fly across and/or hover over in a movement region. Methods for operating an apparatus for additively manufacturing three-dimensional objects may include flying at least one functional unit of an interacting device across a movement region and/or hovering the at least one functional unit in a movement region.

### BRIEF DESCRIPTION

Aspects and advantages will be set forth in part in the following description, or may be obvious from the description, or may be learned through practicing the presently disclosed subject matter.

In one aspect, the present disclosure embraces apparatuses for additively manufacturing three-dimensional objects. Exemplary apparatuses may include at least one interacting device comprising at least one functional unit adapted to fly across and/or hover in a movement region. The functional unit may include a drone unit.

In another aspect, the present disclosure embraces plants for additively manufacturing three-dimensional objects. Exemplary plants may include at least two apparatuses for additively manufacturing of three-dimensional objects and at least one interacting device, such as at least one interacting device for each apparatus. Exemplary interacting devices may include at least one functional unit adapted to fly across and/or hover over in a movement region.

In yet another aspect, the present disclosure embraces methods for operating an apparatus for additively manufacturing three-dimensional objects. Exemplary methods may include flying at least one functional unit of an interacting device across a movement region and/or hovering the at least one functional unit in a movement region.

These and other features, aspects and advantages will become better understood with reference to the following description and appended claims. The accompanying drawings, which are incorporated in and constitute a part of this specification, illustrate exemplary embodiments and, together with the description, serve to explain certain principles of the presently disclosed subject matter.

### BRIEF DESCRIPTION OF THE DRAWINGS

A full and enabling disclosure, including the best mode thereof, directed to one of ordinary skill in the art, is set forth in the specification, which makes reference to the appended Figures, in which:

FIG. 1 shows an inventive apparatus according to a first embodiment in side view;

FIG. 2 shows an inventive apparatus according to a second embodiment in top view; and

FIG. 3 shows an inventive plant.

Repeat use of reference characters in the present specification and drawings is intended to represent the same or analogous features or elements of the present disclosure.

### DETAILED DESCRIPTION

Reference now will be made in detail to exemplary embodiments of the presently disclosed subject matter, one or more examples of which are illustrated in the drawings. Each example is provided by way of explanation and should not be interpreted as limiting the present disclosure. In fact, it will be apparent to those skilled in the art that various modifications and variations can be made in the present disclosure without departing from the scope of the present disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components. The terms “a” and “an” do not denote a limitation of quantity, but rather denote the presence of at least one of the referenced item.

Here and throughout the specification and claims, range limitations are combined and interchanged, and such ranges are identified and include all the sub-ranges contained therein unless context or language indicates otherwise. For example, all ranges disclosed herein are inclusive of the endpoints, and the endpoints are independently combinable with each other.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems.

Exemplary embodiments of the present disclosure will now be described in further detail.

The invention relates to an apparatus for additively manufacturing three-dimensional objects by means of successive layerwise selective consolidation of a build material in a build plane.

Apparatuses for additively manufacturing three-dimensional object are generally known from prior art, e.g. apparatuses that are adapted to selectively consolidate build material and thereby, layerwise built a three-dimensional object. Typically, a process chamber is formed around a process plane by a housing structure limiting the process chamber, e.g. via walls and a ceiling. Hence, usually the process plane is limited by walls of the housing structure enclosing the process chamber. For performing different tasks or actions in the additive manufacturing process respective functional units are provided, e.g. an application unit adapted to apply build material in a build plane which can be consolidated via a consolidation unit, e.g. an irradiation unit fixedly mounted to the process chamber, to build the object. Respective functional units are usually mounted to the process chamber or are carried via respective carrying structures, e.g. gantries, mechanical arms or the like and are therefore, mechanically coupled with the process chamber or the process plane of the apparatus.

Thus, a movement region in which the functional units can be moved is usually limited to the inside of the process chamber, particularly the dimensions of the process plane. Hence, the size of the process chamber limits the size of the build plane and therefore, the maximum size of an object that can be additively built with the apparatus. Further, the number and type of functional units provided inside the process chamber cannot be changed, at least during the same manufacturing process, as usually the process chamber limits an inertized volume that cannot be opened to change the functional units without negatively affecting the atmosphere in the process chamber.

It is an object of the present invention to provide an improved apparatus for additively manufacturing three-dimensional objects, in particular an apparatus that is more versatile.

The object is inventively achieved by an apparatus according to claim 1. Advantageous embodiments of the invention are subject to the dependent claims.

The apparatus described herein is an apparatus for additively manufacturing three-dimensional objects, e.g. technical components, by means of successive selective layerwise consolidation of layers of a powdered build material (“build material”) which can be consolidated by means of an energy source, e.g. an energy beam, in particular a laser beam. A respective build material can be a metal, ceramic or polymer powder. A respective energy beam can be a laser beam. A respective apparatus can be an apparatus in which an application of build material and a consolidation of build material is performed separately, such as a selective laser sintering apparatus, a selective laser melting apparatus or a selective electron beam melting apparatus, for instance. Alternatively, the successive layerwise selective consolidation of build material may be performed via at least one binding material. The binding material may be applied with a corresponding application unit and, for example, irradiated with a suitable energy source, e.g. a UV light source.

The apparatus may comprise a number of functional units which are used during its operation. Exemplary functional units are an irradiation device which is adapted to selectively irradiate a build material layer disposed in the process chamber with at least one energy beam, and a stream generating device which is adapted to generate a gaseous fluid stream at least partly streaming onto or alongside a build plane with given streaming properties, e.g. a given streaming profile, streaming velocity, etc. The gaseous fluid stream is capable of being charged with non-consolidated particulate build material, particularly smoke or smoke residues generated during operation of the apparatus, while streaming onto or alongside the build plane. The gaseous fluid stream is typically inert, i.e. typically a stream of an inert gas, e.g. argon, nitrogen, carbon dioxide, etc.

According to the invention, the apparatus for additively manufacturing three-dimensional objects comprises at least one interacting device with at least one functional unit, in particular a drone unit, which is adapted to fly across and/or hover in a movement region. Thus, deviant from apparatuses known from prior art, at least one functional unit of the interacting device can fly across a movement region or hover in a movement region of the apparatus. Therefore, it is not necessary to mechanically couple the functional unit with the apparatus, e.g. via providing a gantry or a mechanical arm that is somehow connected or coupled with a part of the apparatus. Instead, the functional unit may independently fly relative to the apparatus and/or hover in a position relative to the apparatus.

In particular, it is possible that the functional unit can fly over a build plane and hover over a build plane to perform certain tasks in an additive manufacturing process, inter alia, providing build material, applying build material, consolidating build material and the like. The term “functional unit” in particular “drone unit” may refer to a unit that comprises means for flying and/or hovering the functional unit along a given track or in a given position, respectively. The functional unit may, for example, be described as unmanned aerial vehicle, such as a drone. The functional unit may comprise at least one motor and/or at least one rotor that can generate a force at least partially directed against the force of gravity, thereby causing the functional unit to fly and/or hover. Of course, the respective means for moving the functional unit can be chosen dependent on the specific functional unit, e.g. the amount and size of rotors and the like.

The functional unit may carry respective components for providing the corresponding tasks in the additive manufacturing process, such as an irradiation unit adapted to emit radiation for consolidating build material. Of course, the functional unit may carry a variety of different components, such as components for applying build material, removing build material, applying binder material, irradiating build material, generating a gas stream, or determining parameters of the manufacturing process, such as capturing images of the build plane, in particular relating to a melt pool or a spot of the energy beam in the build plane.

The interacting device is, for example, adapted to move the at least one functional unit in a movement region that is larger than a process plane which contains a build plane. The build plane, as described before, may refer to the plane in which build material is applied to be consolidated, e.g. via selective irradiation with an energy beam or by selective application of a binder material. The process plane in the scope of this application may refer to a plane which comprises the build plane and in which further functional planes may be arranged, such as an overflow plane or a dose plane, for instance. The process plane may further be identical with the build plane, e.g. in additive manufacturing processes in which only a build plane is provided. The process plane may further comprise an edge or a rim surrounding the build plane. By providing an interacting device which is adapted to move the at least one functional unit in a movement region which is larger than the process plane, in particular larger than the build plane, it is possible to fly the functional unit in a defined movement pattern arbitrarily with respect to the build plane allowing for performing movements, in particular movements for different tasks in the additive manufacturing process that are not limited by the size of a process chamber, in particular not limited by walls of a process chamber.

In particular, different tracks and movement patterns can be used that are not limited by walls or ceilings delimiting a process chamber. For example, the functional unit does not have to be decelerated or accelerated over the build plane or at an edge of the build plane, but it is possible to accelerate and decelerate the functional unit before and after the build plane or process plane begins and ends. Therefore, the different tasks or process steps required in an additive manufacturing process can be performed more uniformly and independent of the limitations connected with using a typical process chamber. Thus, there is no chamber arranged around the build plane limiting the movement region of the functional unit. Of course, a limitation or chamber walls which are displaced from the build plane and limit the movement region of the functional unit may be provided, but the functional unit may move freely over or across the build plane, as described before.

The at least one functional unit may be structurally independent from the process plane. Thus, the functional unit may move freely and independently without a mechanical link or coupling necessary which is connected with the process plane in order to move the functional unit. For example, the functional unit may be completely mechanically decoupled from the process plane or other parts of the apparatus. Besides, it is possible to couple the functional unit with other devices providing the functional unit with resources required for performing certain tasks, such as power, operational signals or control commands, an energy beam, build material, inert gas or the like. The structural independence from the process plane allows for moving and guiding the functional unit freely across the build plane and placing the functional unit in any arbitrary position relative to the build plane without any dependence from limitations caused by a mechanic coupling to the process plane.

As described before, the functional unit is particularly adapted to perform at least one action related to at least one process step of the additive manufacturing process. The functional unit may comprise, in particular carry, at least one part of a corresponding device that is required for performing actions related to the additive manufacturing process. Inter alia, the functional unit may comprise an application unit adapted to apply build material in a build plane and/or a consolidation unit adapted to consolidate build material in a build plane and/or a carrying unit adapted to carry the additively built object and/or an unpacking unit adapted to unpack the object and/or a determination unit adapted to determine at least one parameter of the object, particularly a size of the object, and/or the additive manufacturing process, particularly a temperature of at least one region of the build plane during the additive manufacturing process.

Thus, it is possible that the functional unit performs at least one process step of the additive manufacturing step, in particular a build process, an irradiation process or an application process of build material. The functional unit may further be used to unpack the additively built object and move, in particular carry, the object to at least another process station, e.g. a post-processing station. Further, the functional unit may perform at least one pre-processing or post-processing task. The functional unit can also be used to determine parameters of the additive manufacturing process, for example parameters of the object, parameters of an irradiation process, such as beam parameters relating to an energy beam used to irradiate the build material or other parameters relating to process conditions present during the additive manufacturing process, e.g. relating to the gas atmosphere, the temperature in the build plane or in the process chamber, images from the build plane during the additive manufacturing process and the like.

It is possible to use one functional unit to perform multiple tasks, such as application of build material, providing an inert gas and irradiation of build material. Besides, it is also possible to provide special functional units adapted to perform one single task or a special group of tasks, such as providing one functional unit for the application of build material and one functional unit for consolidating the build material, for instance.

In particular, a consolidation unit of the functional unit may be adapted to consolidate build material via at least one energy beam or via at least one filament nozzle or via at least one inkjet or via direct material deposition. Thus, dependent on the additive manufacturing process that is to be performed, different types of consolidation units may be provided with the functional unit. In particular, it is possible that the consolidation unit is adapted to generate or guide an energy beam on material used in the additive manufacturing process. It is also possible that the consolidation unit comprises a filament nozzle via which the filament, in particular made of a polymer build material, may be dispensed to build the three-dimensional object. It is also possible that the consolidation unit is adapted to provide binder material, for example via an ink jet unit. Besides, it is also possible to provide the possibility to directly deposit material via the consolidation unit.

According to another embodiment of the apparatus, at least one supply unit may be adapted to supply the at least one functional unit with at least one resource, in particular process material and/or energy. As a resource, any arbitrary material, component, energy or the like can be provided to the functional unit via the supply unit. For example, it is possible to have a supply unit adapted to supply the functional unit with power, such as electrical power to operate the functional unit, e.g. to drive a motor or generate a force moving the functional unit. Further, the functional unit may receive control commands from the supply unit, e.g. via electrical signals sent to the functional unit.

The supply unit may further provide build material, inert gas or other types of consumable material used in the additive manufacturing process to the functional unit. It is also possible to have a supply unit that can supply energy, such as an energy beam or other types of radiation to the functional unit in order to irradiate build material. Additionally or alternatively, it is possible to supply the functional unit via the supply unit with other types of material used in an additive manufacturing process to consolidate build material, such as binder material, filament or the like.

In other words, it is possible that the supply unit can provide build material and/or gas and/or a consolidation means and/or energy to the at least one functional unit, in particular adapted to recharge at least one storage unit, e.g. an energy storage of the at least one functional unit. Thus, the functional unit may be completely independent and may only be temporarily coupled with the supply unit for recharging the functional unit with the at least one resource. For example, it is possible that build material and/or gas and/or a consolidation means and/or energy is recharged into at least one storage unit of the at least one functional unit, while the functional unit is coupled with the supply unit. The functional unit may, inter alia, comprise different storage units, for example for build material, e.g. a build material tank, and/or for energy, e.g. a battery, and/or for gas, e.g. a gas tank, wherein the functional unit can use or dispense the corresponding resource in the additive manufacturing process and can recharge the resource via the supply unit.

It is also possible that the at least one functional unit may be connected to the supply unit via at least one connection means, in particular at least one fiber and/or cable and/or hose and/or pipe. The connection means can be temporarily or permanently coupled with the functional unit, e.g. for providing an energy beam to the functional unit via an optical fiber. It is also possible that different other types of resources can be supplied to the functional unit, as needed. For example, build material, gas and electrical power may be supplied to the functional unit via the connection means.

Thus, the functional unit may be freely moved with respect to a build plane, wherein at least one connection means may connect the functional unit to the supply unit, e.g. by a flexible cable and/or hose and/or fiber providing required resources to the functional unit. Of course, a combination of recharging at least one storage unit in the functional unit and providing other resources via a connection means to the functional unit is also possible. Further, different types of functional units may be connected via a connection means to a supply unit, whereas other functional units may be provided with resources by only temporarily connecting the functional unit with the supply unit. It is also possible that the connection between the supply unit and the functional unit allows a transfer of resources in both directions, e.g. a removal of non-consolidated build material from a powder bed or the transmission of determined parameters from the functional unit to a corresponding control unit, for instance.

The apparatus may further comprise at least one functional unit comprising a communication unit which is adapted to send and/or receive interacting information to or from at least one other functional unit and/or to or from at least one communication device. In other words, at least one functional unit may be provided with a communication unit via which interacting information can be sent or received. For example, the functional unit may send or receive interacting information which are required for the additive manufacturing process, such as control commands, or other parameters relating to the additive manufacturing process. In particular, determined parameters may be transmitted via the communication unit to at least one other functional unit or to a central communication device. Further, different types of information relating to the functional unit itself may be transmitted to at least one other functional unit or to at least one communication device, e.g. the status of at least one storage unit of the functional unit, the temperature of the functional unit or the availability of the functional unit. In particular, a network can be formed by providing at least two functional units adapted to communicate via the communication unit. Particularly, a central communication device can be provided that can receive information from at least two different functional units and send information to these functional units.

The at least one interacting device may further be adapted to receive build information relating to at least one area of the build plane to which the at least one functional unit is at least temporarily assigned. For example, at least one functional unit may be assigned to a specific region of the build plane in which the functional unit can perform one or more tasks that relate to the additive manufacturing process. For example, the interacting device can assign the functional unit to a build plane of an apparatus to apply build material or consolidate the build material, as described before. The assignment can be chosen only temporarily, wherein after the functional unit completed the task, the functional unit can be assigned to another part of the build plane or to another build plane. It is also possible that at least two apparatuses are provided, wherein only one apparatus comprises at least one interacting device with at least one functional unit. It is also possible that at least two apparatuses are assigned to the same interacting device, e.g. a central interacting device comprising one or more functional units which can be arbitrarily assigned to the at least two apparatuses.

Besides, the invention relates to a plant for additively manufacturing three-dimensional objects, comprising at least two apparatuses for additively manufacturing three-dimensional objects by means of successive layerwise consolidation of a build material, wherein each apparatuses comprises at least one build plane, in particular at least two inventive apparatuses, as described before, wherein the plant comprises at least one interacting device, in particular for each apparatus, which interacting device comprises at least one functional unit adapted to fly across and/or hover in a movement region. Hence, it is possible that the plant comprises a central interacting device with at least one functional unit assigned to one of the at least two apparatuses, e.g. based on a demand information the functional unit can be assigned to one of the apparatuses. In particular, the interacting device may comprise more than one functional unit, wherein the assignment of the functional unit to one of the at least two apparatuses can be based on the demand information relating to a work load of the individual apparatus. Of course, the assignment of the functional units to the respective apparatuses is only temporary and can be changed as needed.

It is also possible that the plant comprises at least two interacting devices, wherein the plant is adapted to assign at least two functional units of at least two different interacting devices to different apparatuses or to the same apparatus dependent on a demand information, particularly relating to a work load of the at least one apparatus or at least one functional unit. Hence, it is possible that each apparatus can have its own interacting device with one or more functional units, wherein the plurality of functional units provided by the at least two interacting devices can be assigned arbitrarily to one of the at least two apparatuses. In other words, dependent on the work load of the individual apparatuses, for example dependent on the current status of the additive manufacturing processes performed on the apparatuses, an assignment of functional units to the individual apparatuses can be performed. Thus, dependent on the work load one or more functional units can be assigned to one apparatus and perform respective tasks in the additive manufacturing process performed on this apparatus. Therefore, the functional units can be used as efficient as possible, as the number of functional units temporarily assigned to one of the apparatuses may be chosen dependent on the work load of the apparatus.

Besides, the invention relates to an interacting device for an apparatus for additively manufacturing three-dimensional objects by means of successive layerwise selective consolidation of a build material, in particular for an inventive apparatus, as described before, wherein the interacting device comprises at least one functional unit that is adapted to fly across and/or hover in a movement region. Further, the invention relates to a method for operating an apparatus for additively manufacturing three-dimensional objects by means of successive layerwise consolidation of a build material, comprising the steps: flying at least one functional unit of an interacting device, in particular an inventive interacting device, as described before, across a movement region and/or hovering the at least one functional unit in a movement region. Self-evidently, the method may be performed on the inventive plant comprising at least two apparatuses, as described before.

Of course, all details, features and advantages described with respect to the inventive apparatus are fully transferable to the inventive plant, the inventive interacting device and the inventive method and vice versa.

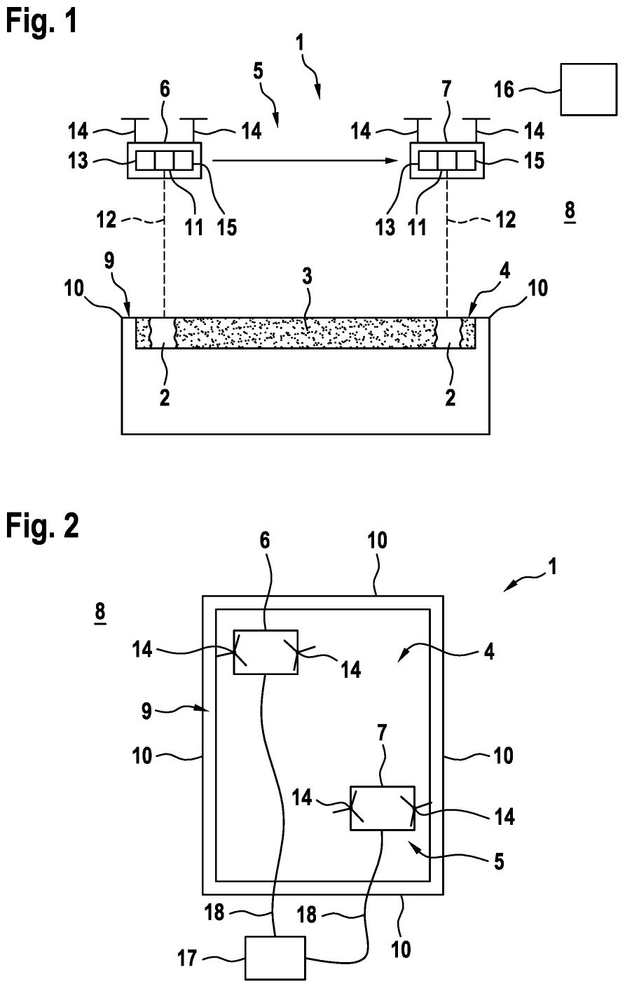

FIG. 1 shows an apparatus 1 for additively manufacturing three-dimensional objects 2 by means of successive layerwise selective consolidation of a build material 3 in a build plane 4. The apparatus 1 comprises an interacting device 5 with functional units 6, 7, wherein in the sense of simplicity only two functional units 6, 7 are depicted. Self-evidently, the interacting device 5 may comprise a plurality of functional units 6, 7. The functional units 6, 7, e.g. drone units, are adapted to fly across and/or hover in a movement region 8. In particular, the functional unit 6, 7 may fly across a process plane 9 that comprises the build plane for or hover in any arbitrary position above the process plane 9.

In particular, the functional units 6, 7 may be moved in a movement region 8 which is larger than the process plane 9, wherein the functional units 6, 7 may be moved across edges 10 of the process plane 9. The process plane 9 or the build plane for a, respectively, may be regarded as freely standing build table on which build material 3 may be applied and selectively consolidated in the additive manufacturing process in order to build the three-dimensional objects 2. The movement region 8 may be regarded as volume surrounding or neighboring the build plane 4 in which the functional units 6, 7 can be moved.

The functional units 6, 7 are structurally independent from the process plane 9, wherein the functional unit 6, 7 can particularly be moved independently from the process plane 9. The process plane 9 is not connected with any walls or ceiling that would limit a process chamber in which the functional unit 6, 7 can be moved. The functional units 6, 7 are used in the additive manufacturing process performed on the apparatus 1 for performing actions or tasks relating to process steps of the additive manufacturing process. Inter alia, the functional unit 6, 7 may apply build material 3 in the build plane 4, consolidate the build material 3 to layerwise build the object 2 or multiple objects 2 in the build plane 4. For example, the movement region 8 may entirely be filled with inert gas for providing a defined atmosphere for the additive manufacturing process.

In this exemplary embodiment, the functional units 6, 7 are identical, wherein it is also possible to provide functional units 6, 7 that differ, in particular with respect to the components that are carried via the functional units 6, 7 for performing different tasks in the additive manufacturing process. Each functional unit 6, 7 may, for example, comprise a consolidation unit 11 with which the build material 3 may be selectively consolidated, for example a beam guiding unit via which an energy beam 12 may be emitted and guided to the build plane 4. It is also possible that the consolidation unit 11 is built as binder jet dispensing unit, direct material deposition unit or irradiation unit emitting unfocused radiation into the direction of the build plane 4.

The functional units 6, 7 further comprise an energy storage 13, e.g. for storing energy via which the functional unit 6, 7 may be moved, e.g. by providing energy for driving rotors 14 for flying and/or hovering the functional units 6, 7. Self-evidently, the rotors 14 are connected to respective motors (not depicted). The number and type of rotors 14 or other means for moving the functional units 6, 7 can, of course, be chosen adequately. Further, the functional units 6, 7 comprise a build material storage 15 from which the functional units 6, 7 may apply build material 3 in the build plane 4. It is also possible that the functional units 6, 7 comprise a storage unit for providing inert gas to the build plane 4, e.g. for inertizing a region above the build plane 4 to avoid a contact between the build material 3 and ambient air, in particular oxygen.

The functional units 6, 7 may comprise handling units adapted to remove the non-consolidated build material 3 surrounding the object 2 and/or handle the object 2 by carrying the object 2 to a further processing station, for instance, after the additive manufacturing process is finished. Further, FIG. 1 depicts a supply unit 16 that is adapted to supply the functional units 6, 7 with at least one resource, such as build material 3, inert gas, energy for the energy storage 13 and the like. For supplying the resources to the functional units 6, 7 the functional units 6, 7 may be temporarily connected with the supply unit 16 to recharge the resources as needed. Of course, it is also possible that resources removed from the process, such as removed non-consolidated build material can be dispensed in the supply unit 16. Further, separate supply units 16 may be provided for recharging or emptying the respective storage units of the functional units 6, 7.

FIG. 2 depicts an apparatus 1 according to a second embodiment, wherein the same numerals are used for same parts. Exemplarily, the apparatus 1 depicted in FIG. 2 also comprises two functional units 6, 7 that can be moved in a movement region 8 which is larger than the process plane 9, in particular larger than the build plane 4. In other words, the functional units 6, 7 may be moved beyond the edges 10 of the process plane 9 in that the functional units 6, 7 may be moved (uniformly) across the build plane 4 for uniformly consolidating build material 3 or perform other tasks required in the additive manufacturing process.

In this embodiment alternative or additional to the supply unit 16, a supply unit 17 is provided that connects the functional units 6, 7 via connection means 18 for supplying resources to the functional units 6, 7. It is also possible to provide a supply unit 17 in the apparatus 1 that is depicted in FIG. 1, wherein an arbitrary combination of recharging resources via the separate supply unit 16 to which the functional unit 6, 7 only temporarily connect and the use of connection means 18 that permanently connect the functional units 6, 7 with a corresponding supply unit 17 is possible.

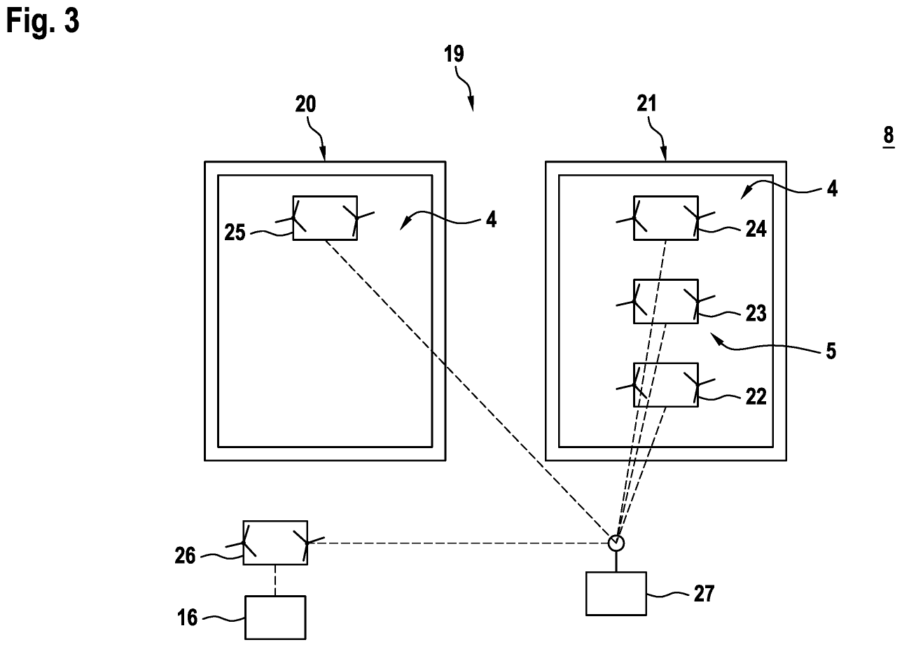

FIG. 3 shows a plant 19 that comprises two apparatuses 20, 21 and an interacting device 5 for performing certain tasks in the additive manufacturing process performed on the apparatuses 20, 21. The interacting device 2 in this exemplary embodiment comprises five functional units 22, 23, 24, 25 and 26, wherein the assignment of the functional units 22-26 is performed dependent on a demand information of the apparatuses 20, 21, e.g. based on a work load of the apparatuses 20, 21. In this exemplary embodiment, one functional unit 26 is connected to a supply unit 16, as described before. Self-evidently, as also described before, it is also possible to provide a supply unit 17 or combine the features of the supply unit 16 with the supply unit 17. In particular, each of the functional units 22-26 may comprise a storage unit for resources required to perform the additive manufacturing process.

In the situation that is depicted in FIG. 3, the demand for functional units 22-26 differs with respect to the apparatuses 20, 21. For example in the layer that is currently consolidated, the build plane 4 of the apparatus 21 comprises more structures that have to be irradiated than in the current layer in the build plane 4 of the apparatus 20. Therefore, the current work load of the apparatus 21 is higher than the work load of the apparatus 20. Therefore, three functional units 22, 23 and 24 are assigned to perform tasks in the additive manufactured process performed on the additive manufacturing apparatus 21, whereas the functional unit 25 is assigned to perform tasks on the apparatus 20.

Further, a communication unit 27 is depicted that is adapted to communicate with the functional units 22-26, e.g. receive information from the functional units 22-26, such as a fill level of different storage units of the functional units 22-26 or results from determination processes performed via the functional units 22-26. For example, one or more of the functional units 22-26 may comprise a determination unit, such as a camera, for determining process parameters during the additive manufacturing process, e.g. capturing images of the build plane 4. It is also possible that different parameters of the additive manufacturing, such as the temperature of a consolidation zone, the spot of the energy beam, such as the intensity distribution in the spot of the energy beam or the size of the spot of the energy beam, parameter relating to the gas atmosphere and the like, can be determined via a corresponding determination unit comprised in one or more of the functional units 22-26. For example, it is possible that each of the functional units 22-26 comprise multiple or individual determination units, e.g. suitable for determining different parameters during the additive manufacturing process.

Thus, it is possible to communicate via the communication unit 27 between the functional units 22-26 and therefore, move functional units 22-26 in the movement region 8 to perform different tasks in the additive manufacturing process, as needed. Inter alia, a demand information may be generated and guided to the communication device 27 in order to generate control commands for the individual functional units 22-26. Each functional unit 22-26 may further communicate status information to the communication device 27, which can be connected to a control unit (not depicted) of the plant 19, in order to provide information relating to the status of the individual functional units 22-26, such as the capacity information of the storage units of the functional units 22-26, current control commands that are executed, and the like.

Self-evidently, all details, features and advantages described with respect to the individual embodiments can arbitrarily be combined, exchanged and transferred. Of course, the inventive method may be performed on the inventive plant and the inventive apparatuses.

Further aspects of the invention are provided by the subject matter of the following clauses:

1. An apparatus (1, 21, 22) for additively manufacturing three-dimensional objects (2) by means of successive layerwise selective consolidation of a build material (3) in a build plane (4), characterized by at least one interacting device (5) comprising at least one functional unit (6, 7, 22-26), in particular drone unit, adapted to fly across and/or hover in a movement region (8).

2. The apparatus of any preceding clause, wherein the interacting device (5) is adapted to move the at least one functional unit (6, 7, 22-26) in a movement region (8) that is larger than a process plane (9) which contains a build plane (4).

3. The apparatus of any preceding clause, wherein the apparatus (1, 21, 22) is constructed in that at least one functional unit (6, 7, 22-26) is adapted to fly over at least one edge (10) of the process plane (9).

4. The apparatus of any preceding clause, wherein the at least one functional unit (6, 7, 22-26) is structurally independent from the process plane (9).

5. The apparatus of any preceding clause, wherein the functional unit (6, 7, 22-26) is adapted to perform at least one action relating to at least one process step of the additive manufacturing process.

6. The apparatus of any preceding clause, wherein the at least one functional unit (6, 7, 22-26) comprises an application unit adapted to apply build material (3) in a build plane (4) and/or a consolidation unit (11) adapted to consolidate build material (3) in a build plane (4) and/or a carrying unit adapted to carry the additively built object and/or an unpacking unit adapted to unpack the object and/or a determination unit adapted to determine at least one parameter of the object, particularly a size of the object, and/or the additive manufacturing process, particularly a temperature of at least one region of the build plane (4) during the additive manufacturing process.

7. The apparatus of any preceding clause, wherein the consolidation unit (11) of the at least one functional unit (6, 7, 22-26) is adapted to consolidate build material (3) via at least one energy beam (12) or via at least one filament nozzle or via at least one ink jet or via direct material deposition.

8. The apparatus of any preceding clause, characterized by at least one supply unit (16, 17) adapted to supply the at least one functional unit (6, 7, 22-26) with at least one resource, in particular process material and/or energy.

9. The apparatus of any preceding clause, wherein the at least one supply unit (16, 17) is adapted to provide the at least one functional unit (6, 7, 22-26) with build material (3) and/or gas and/or a consolidation means and/or energy, in particular adapted to recharge at least one energy storage (13) of the at least one functional unit (6, 7, 22-26).

10. The apparatus of any preceding clause, wherein the at least one functional unit (6, 7, 22-26) is connected to the supply unit (16, 17) via at least one connection means (18), in particular at least one fiber and/or cable and/or hose and/or pipe.

11. The apparatus of any preceding clause, wherein the at least one functional unit (6, 7, 22-26) comprises a communication unit adapted to send and/or receive interacting information to or from at least one other functional unit (6, 7, 22-26) and/or to or from at least one communication device (27).

12. The apparatus of any preceding clause, wherein the at least one interacting device (5) is adapted to receive build information relating to at least one area of the build plane (4) to which the at least one functional unit (6, 7, 22-26) is at least temporarily assigned.

13. A plant (19) for additively manufacturing three-dimensional objects (2), comprising at least two apparatuses (1, 21, 22) for additively manufacturing of three-dimensional objects by means of successive layerwise consolidation of a build material (3) providing at least one build plane (4) each, in particular at least two apparatuses (1, 21, 22) according to any preceding clause, wherein the plant (19) comprises at least one interacting device (5), in particular for each apparatus (1, 21, 22), which interacting device (5) comprises at least one functional unit (6, 7, 22-26) adapted to fly across and/or hover over in a movement region (8).

14. The plant of any preceding clause, wherein the plant (19) comprises at least two interacting devices (5), wherein the plant (19) is adapted to assign at least two functional units (6, 7, 22-26) of the same interacting device (5) or of at least two different interacting devices (5) to the same apparatus (1, 21, 22) dependent on a demand information, particularly relating to a work load of the at least one apparatus (1, 21, 22) or at least one functional unit (6, 7, 22-26).

15. An interacting device (5) for an apparatus (1, 21, 22) for additively manufacturing three-dimensional objects (2) by means of successive layerwise selective consolidation of a build material (3), in particular for an apparatus(1, 21, 22) of any preceding clause, wherein the interacting device (5) comprises at least one functional unit (6, 7, 22-26) that is adapted to fly across and/or hover in a movement region (8).

16. A method for operating an apparatus (1, 21, 22) for additively manufacturing three-dimensional objects (2) by means of successive layerwise consolidation of a build material (3), comprising: flying at least one functional unit (6, 7, 22-26) of an interacting device (5), in particular an interacting device (5) of any preceding clause, across a movement region (8) and/or hovering the at least one functional unit (6, 7, 22-26) in a movement region (8).

17. The method of any preceding clause, comprising: flying the least one functional unit (6, 7, 22-26) over at least one edge (10) of the process plane (9), wherein the apparatus (1, 21, 22) is constructed in that the at least one functional unit (6, 7, 22-26) is adapted to fly over the at least one edge (10) of the process plane (9).

18. The method of any preceding clause, comprising: performing at least one action relating to at least one process step of the additive manufacturing process, wherein the functional unit (6, 7, 22-26) is adapted to perform the at least one action relating to the at least one process step of the additive manufacturing process.

19. The method of any preceding clause, comprising: supplying the at least one functional unit (6, 7, 22-26) with at least one resource, in particular process material and/or energy, wherein the at least one supply unit (16, 17) is adapted to supply the at least one functional unit (6, 7, 22-26) with the at least one resource, in particular process material and/or energy.

20. The method of any preceding clause, comprising: sending and/or receiving interacting information to or from at least one other functional unit (6, 7, 22-26) and/or to or from at least one communication device (27), wherein the at least one functional unit (6, 7, 22-26) comprises a communication unit adapted to send and/or receive interacting information to or from the at least one other functional unit (6, 7, 22-26) and/or to or from the at least one communication device (27).

This written description uses exemplary embodiments to describe the presently disclosed subject matter, including the best mode, and also to enable any person skilled in the art to practice such subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An apparatus for additively manufacturing three-dimensional objects by means of successive layerwise selective consolidation of a build material in a build plane, characterized by at least one interacting device comprising at least one functional unit adapted to fly across and/or hover in a movement region.

2. The apparatus of claim 1, wherein the interacting device is adapted to move the at least one functional unit in a movement region that is larger than a process plane which contains a build plane.

3. The apparatus of claim 1, wherein the apparatus is constructed in that the at least one functional unit is adapted to fly over at least one edge of the process plane.

4. The apparatus of claim 1, wherein the at least one functional unit is structurally independent from the process plane.

5. The apparatus of claim 1, wherein the at least one functional unit is adapted to perform at least one action relating to at least one process step of the additive manufacturing process.

6. The apparatus of claim 5, wherein the at least one functional unit comprises an application unit adapted to apply build material in a build plane and/or a consolidation unit adapted to consolidate build material in a build plane and/or a carrying unit adapted to carry the additively built object and/or an unpacking unit adapted to unpack the object and/or a determination unit adapted to determine at least one parameter of the object and/or the additive manufacturing process.

7. The apparatus of claim 6, wherein the consolidation unit of the at least one functional unit is adapted to consolidate build material via at least one energy beam, or via at least one filament nozzle, or via at least one ink jet, or via direct material deposition.

8. The apparatus of claim 1, characterized by at least one supply unit adapted to supply the at least one functional unit with at least one resource.

9. The apparatus of claim 8, wherein the at least one supply unit is adapted to provide the at least one functional unit with build material and/or gas and/or a consolidation means and/or energy.

10. The apparatus of claim 9, wherein the at least one functional unit is connected to the at least one supply unit via at least one connection means.

11. The apparatus of claim 1, wherein the at least one functional unit comprises a communication unit adapted to send and/or receive interacting information to or from at least one other functional unit and/or to or from at least one communication device.

12. The apparatus of claim 11, wherein the at least one interacting device is adapted to receive build information relating to at least one area of the build plane to which the at least one functional unit is at least temporarily assigned.

13. A plant for additively manufacturing three-dimensional objects, comprising at least two apparatuses for additively manufacturing of three-dimensional objects by means of successive layerwise consolidation of a build material providing at least one build plane each, wherein the plant comprises at least one interacting device, wherein the at least one interacting device comprises at least one functional unit adapted to fly across and/or hover over in a movement region.

14. The plant of claim 13, wherein the plant comprises at least two interacting devices, wherein the plant is adapted to assign at least two functional units of the same interacting device or of at least two different interacting devices to the same apparatus dependent on a demand information.

15. The plant of claim 13, wherein the interacting device is adapted to move the at least one functional unit in a movement region that is larger than a process plane which contains a build plane.

16. A method for operating an apparatus for additively manufacturing three-dimensional objects by means of successive layerwise consolidation of a build material, comprising:
flying at least one functional unit of an interacting device across a movement region and/or hovering the at least one functional unit in a movement region.

17. The method of claim 16, comprising:
flying the least one functional unit over at least one edge of the process plane, wherein the apparatus is constructed in that the at least one functional unit is adapted to fly over the at least one edge of the process plane.

18. The method of claim 16, comprising:
performing at least one action relating to at least one process step of the additive manufacturing process, wherein the functional unit is adapted to perform the at least one action relating to the at least one process step of the additive manufacturing process.

19. The method of claim 16, comprising:
supplying the at least one functional unit with at least one resource, wherein the at least one supply unit is adapted to supply the at least one functional unit with the at least one resource.

20. The method of claim 16, comprising:
sending and/or receiving interacting information to or from at least one other functional unit and/or to or from at least one communication device, wherein the at least one functional unit comprises a communication unit adapted to send and/or receive interacting information to or from the at least one other functional unit and/or to or from the at least one communication device.
